(19) United States
(12) Patent Application Publication
(10) Pub. No.: US 2026/0236453 A1
(43) Pub. Date: Aug. 13, 2026

(54) METHODS FOR IMPROVING LATENCY AND DATA CONSISTENCY IN LARGE DATABASES FOR BIDIRECTIONAL LOOKUP

(71) Applicants: Lemon Inc., Grand Cayman (KY); Beijing Youzhuju Network Technology Co., Ltd., Beijing (CN)

(72) Inventors: Aditi TOSHNIWAL, SINGAPORE (SG); Quang Tu TON, SINGAPORE (SG); Tongxiang SHI, Beijing (CN); Soh Chee KIAN, SINGAPORE (SG)

(21) Appl. No.: 19/152,624

(22) PCT Filed: Feb. 1, 2024
(86) PCT No.: PCT/CN2024/075304

§ 371 Date: Jul. 31, 2025

(30) Foreign Application Priority Data
Feb. 1, 2023 (SG) 10202300253R

(51) Int. Cl. G06F 16/23; G06F 16/22; G06F 16/2455

(52) U.S. Cl. CPC G06F 16/2365; G06F 16/2255; G06F 16/24552

(57) ABSTRACT

A computer-implemented method comprises a step of receiving from users respective primary entity-IDs. Each primary entity-ID comprise a first and second bit string. The method further comprises a step of generating respective mapped-IDs from each of the primary entity-IDs, such that i) each of the mapped-IDs is unique, and ii) the mapped-IDs each comprise the first bit string of the primary entity-ID and a third bit string different from the second bit string of the primary entity-ID.

### CROSS-REFERENCE TO RELATED APPLICATIONS

This application claims priority to Singapore Application No. 10202300253R, entitled METHODS FOR IMPROVING LATENCY AND DATA CONSISTENCY IN LARGE DATABASES FOR BIDIRECTIONAL LOOKUP, filed on Feb. 1, 2023, the entire contents of that application being incorporated herein by reference in its entirety.

### TECHNICAL FIELD

The present application relates to databases and more specifically to methods for improving latency and data consistency in large databases for bidirectional lookup.

### BACKGROUND

Web applications or services may require to create, store and use a bidirectional mapping between associated data elements. To this end, for any given data element an associated element may be derived, and the forward and reverse mapping may be stored in a database table. Problems of scalability, latency and data consistency arise when the number of records stored in such a database table becomes large or the database is queried from different geographical regions. Conventional methods and tools for addressing these problems are insufficient, in particular in cases when the web service requires support of bidirectional mapping for billions of associated data elements, and global deployment.

### SUMMARY

The present invention aims to provide new and useful methods for generating a mapped-ID from an entity-ID, and methods and database server for providing a client device with a mapped-ID. The present invention enables, for example, a database for bidirectional lookup between entity-IDs and mapped-IDs which can be partitioned into a distributed database such that the use of distributed transactions is avoided during both read and write requests. Further, the database may have reduced storage size while still ensuring data consistency. The present invention achieves this, firstly by storing in each row of the database an entity-ID, the associated mapped-ID, and a shard key indicating into which partition of the distributed database the row belongs, and secondly by generating the mapped-ID from the entity-ID such that the mapped-ID is unique to the entity-ID while either of the entity-ID or mapped-ID can be used to generate the shard key. The present invention may thereby improve the speed of storing a new mapping, and leverages local database transactions to ensure data atomicity instead of involving distributed transaction.

The present invention further enables, for example, storing of replicas of the database on servers located in different geographical regions while preventing data inconsistencies when conflicting requests for storing a mapping (i.e. an entity-ID and an associated mapped-ID) are made simultaneously from client devices located in different regions. The present invention achieves this by initially allowing the received mapping to be stored in the replica of the request receiving server. The mapping is then transmitted to the other servers which attempt to update their replicas with the received mapping. If a conflict between the received mapping and a mapping already stored on a particular server arises, the affected server determines the correct mapping by querying the relevant mappings stored on the other servers, such that the affected server can update its replica of the database with the correct mapping. Further the affected server transmits the correct mapping to other servers such that the other servers can correct their replica if needed. The present invention may facilitate improved data consistency across multiple replicas of the database deployed in different geographical regions without increasing the latency of write requests.

The present invention may further enable, for example, improved consistency of processing lookup requests by users associated with a first service, regardless of the traffic load imposed by users associated with a second service. The present invention may achieve this by using two memories which cache the (common) database, and directing lookup requests from users associated with the first service to one of the memories and directing lookup requests from users associated with the first service to one of the memories. The present invention may thereby protect users associated with the first service from experiencing inconsistent service caused by (e.g. spiky) traffic load of user associated with the second service.

The present invention may further enable, for example, a reduction of lookup requests performed on the database for repeated lookup requests, i.e. requests made by the same user for the same mapping. The present invention may achieve this by storing the requested mapping, i.e. an entity-ID and associated mapped-ID, on the user device in response to an initial lookup request. The mapping can be stored in form of an encrypted cookie with a predetermined lifetime. Any subsequent lookup request is sent with the encrypted cookie such that when the request is received and the cookie is still valid, instead of searching the database, the cookie can be decrypted and the decrypted mapping can be used to serve the lookup request. The present invention may thereby reduce a read load on the database, and improve the availability of the lookup service in cases of failure or downtime of the database.

According to a first aspect of the present invention there is provided a computer-implemented method. The method comprises a step of receiving from users respective primary entity-IDs. Each primary entity-ID comprises a first and second bit string. The method further comprises a step of generating respective mapped-IDs from each of the primary entity-IDs, such that i) each of the mapped-IDs is unique, and ii) the mapped-IDs each comprise the first bit string of the primary entity-ID and a third bit string different from the second bit string of the primary entity-ID.

The first bit string may be an initial sequence of bits of the primary entity-ID or any other appropriate sequence or set of bits of the primary entity-ID.

Optionally, the first bit strings have a bit length N, and the primary entity-IDs and the mapped-IDs comprise the first bit strings as the N least significant bits. The bit length N of each first bit string may be 10, and each mapped-ID may have a bit length of 64.

Optionally, the method may further comprise maintaining a counter, wherein the third bit strings of the mapped-ID comprises counter information obtained from the counter.

Optionally, the method may further comprise, for each primary entity-ID, a step of generating, using a hash function, a shard key from the primary entity-ID or the mapped-ID, wherein the hash function generates the shard key based on a value of the first bit string.

Optionally, the method may further comprise, for each primary entity-ID, a step of storing the primary entity-ID, the mapped-ID, and the shard key in the same row of a database. The database may be configured as a partitioned database comprising a plurality of shards. Each shard may be associated with a different shard key value. Storing the primary entity-ID, the mapped-ID, and the shard key in the same row of a database may comprise storing the primary entity-ID, the mapped-ID, and the shard key in the same row of a shard associated with the value of the shard key.

According to a second aspect of the present invention there is provided a computer-implemented method of resolving conflicts between a first and a second database. The first and second databases have respective pluralities of rows. Each row stores an entity-ID and a mapped-ID associated with the entity-ID. The method comprises steps of (a) storing a new entity-ID and a new mapped-ID associated with the entity-ID in a new row of the first database, (b) determining a conflict between the new entity-ID and new mapped-ID and an existing entity-ID and associated existing mapped-ID stored in the second database, (c) determining a valid mapped-ID associated with the new entity-ID, and (d) conditional on determining that the valid mapped-ID and the existing mapped-ID stored in the second database are different, updating the second database based on the new entity-ID and the associated valid mapped-ID.

Optically, step (b) of the method may comprise determining that the new entity-ID and the existing entity-ID are the same, and that the new mapped-ID and the existing mapped-ID are different.

Optically, a third database may have a further plurality of rows, each row storing an entity-ID and a mapped-ID associated with the entity-ID, and step (d) of the method may comprise retrieving, from the third database, a further mapped-ID associated with the new mapped-ID, selecting as the valid mapped-ID associated with the new entity-ID, one of the new mapped-ID, the existing mapped-ID stored in the second database and the further mapped-ID retrieved from the third database. The step of selecting the valid mapped-ID may comprise determining a counter value for each of the new mapped-ID, the existing mapped-ID stored in the second database and the further mapped-ID retrieved from the third database, and select, as the valid mapped-ID, the mapped-ID with the lowest counter value. Alternatively, the first, second and third databases may further store in each row a creation timestamp specifying the time when the mapped entity-ID stored in said row was created, and the step of selecting the valid mapped-ID may comprise selecting from the new mapped-ID, the existing mapped-ID stored in the second database and the further mapped-ID retrieved from the third database the one with the earliest timestamp.

Optionally, the method may further comprise step (e) of, conditional on determining that the valid mapped-ID and the new mapped-ID are different, updating the first database based on the new entity-ID and the associated valid mapped-ID, and step (f) of, conditional on determining that the valid mapped-ID and the further mapped-ID retrieved from the third database are different, updating the third database based on the new entity-ID and the associated valid mapped-ID.

Optionally, the method may further comprise an initial step of generating the new mapped-ID from the new entity-ID according to the first aspect of the invention.

According to a third aspect of the present invention there is provided a computer-implemented method of processing, by a database server, a request from a client device for providing a mapped-ID associated with a primary entity-ID. The database server stores a primary copy of a database having a plurality of rows. Each row comprises one of a plurality of entity-IDs and a mapped-ID associated with the entity-ID. The database server further stores first and second cached copies of the database. The method comprises step (a) of receiving the request from the client device, the request comprising the primary entity-ID and service information specifying whether the request is associated with a first or second service. The method further comprises, conditional on determining that the service information specifies that the request is associated with the first service, step (b1) of determining whether the mapped-ID associated with the primary entity-ID is stored in the first cached copy, step (b2) of, conditional on determining that the mapped-ID is not stored in the first cached copy, determining whether the mapped-ID associated with the primary entity-ID is stored in the primary copy of the database, and step (b3) of, conditional on determining that the mapped-ID is stored in one of the first cached copy and the primary copy of the database, obtaining the mapped-ID and providing the mapped-ID to the client device. The method further comprises, conditional on determining that the service information specifies that the request is associated with the second service, step (c1) of determining whether the mapped-ID associated with the primary entity-ID is stored in the second cached copy, step (c2) of, conditional on determining that the mapped-ID is not stored in the second cached copy, determining whether the mapped-ID associated with the primary entity-ID is stored in the primary copy of the database, and step (c3) of, conditional on determining that the mapped-ID is stored in one of the second cached copy and primary copy of the database, obtaining the mapped-ID and transmitting the mapped-ID to the client device. The method further comprises, conditional on determining that the mapped-ID is not stored in the primary copy of the database, step (d1) of generating the mapped-ID associated with the primary entity-ID, step (d2) of transmitting the mapped-ID to the client device, and step (d3) of storing the primary entity-ID and the associated mapped-ID in a new row of the database.

Optionally, the first and second cached copies may fully cache the database, and the database server may further store a first partially cached copy of the first cached copy and a second partially cached copy of the second cached copy. Step (b1) of the method may comprise determining whether the mapped-ID associated with the primary entity-ID is stored in the first partially cached copy, and conditional on determining that the mapped-ID is not stored in the first partially cached copy, determining whether the mapped-ID associated with the primary entity-ID is stored in the first cached copy. Step (c1) of the method may comprise determining whether the mapped-ID associated with the primary entity-ID is stored in the second partially cached copy, and conditional on determining that the mapped-ID is not stored in the second partially cached copy, determining whether the mapped-ID associated with the primary entity-ID is stored in the second cached copy.

According to a fourth aspect of the present invention there is provided a computer-implemented method. The method comprises step (a) of receiving, from a client device, a first request for providing an application with a mapped-ID associated with a primary entity-ID, the request comprising the primary entity-ID, step (b) of retrieving the mapped-ID associated with the primary entity-ID from a database, step (c) of providing, to the application, the mapped-ID, step (d) of processing the primary entity-ID and the mapped-ID with an encryption key to generate an encrypted primary entity-ID and an encrypted mapped-ID, and step (e) of transmitting, to the client device, the encrypted entity-ID, the encrypted mapped-ID and expiration information specifying a lifetime of the encrypted entity-ID and the encrypted mapped-ID.

Optionally, the method may further comprise step (f) of receiving, from the client device, a second request for providing the application with the mapped-ID associated with the primary entity-ID, the request comprising the primary entity-ID, the encrypted entity-ID, the encrypted mapped-ID and expiration information, step (g) of determining, based on the expiration information, whether the encrypted primary entity-ID and the encrypted mapped-ID are valid, and step (h) of, conditional on determining that the encrypted primary entity-ID and the encrypted mapped-ID are valid, decrypting, using the encryption key, the received encrypted primary entity-ID and the encrypted mapped-ID, and providing the decrypted mapped-ID to the application.

According to a fifth aspect of the present invention there is provided a system comprising one or more computers and one or more storage devices storing instructions that when executed by the one or more computers cause the one or more computers to perform the first, second, third or fourth aspect of the invention.

According to a sixth aspect of the present invention there is provided one or more non-transitory computer storage media storing instructions that when executed by one or more computers cause the one more computers to perform the first, second, third or fourth of the invention.

According to a seventh aspect of the present invention there is provided a system comprising first, and second database servers. The first and second database servers store respectively first and second databases. The databases each have a plurality of rows, each row storing an entity-ID and a mapped-ID associated with the entity-ID. The first database server is configured to store a new entity-ID and a new mapped-ID associated with the entity-ID in a new row of the first database, and transmit the new entity-ID and the new mapped-ID to the second database server. The second database server configured to determine a conflict between the received new entity-ID and new mapped-ID and an existing entity-ID and associated existing mapped-ID stored in the second database. The second database server further configured to determine a valid mapped-ID associated with the new entity-ID, and conditional on determining that the valid mapped-ID and the existing mapped-ID stored in the second database are different, update the second database based on the new entity-ID and the associated valid mapped-ID.

Features of the system may be as explained above in relation to the second aspect of the invention.

According to an eighth aspect of the present invention there is provided a database server for processing a request from a client device for providing a mapped-ID associated with a primary entity-ID. The database server is configured to store a primary copy of a database having a plurality of rows. Each row comprising one of a plurality of entity-IDs and a mapped-ID associated with the entity-ID. The database server is configured to further store first and second cached copies of the database. The database server further is configured to receive the request from the client device, the request comprises the primary entity-ID and service information specifying whether the request is associated with a first or second service. The database server is configured to, conditional on determining that the service information specifies that the request is associated with the first service, determine whether the mapped-ID associated with the primary entity-ID is stored in the first cached copy, and conditional on determining that the mapped-ID is not stored in the first cached copy, determine whether the mapped-ID associated with the primary entity-ID is stored in the primary copy of the database. The database server is further configured to, conditional on determining that the mapped-ID is stored in one of the first cached copy and the primary copy of the database, obtain the mapped-ID and providing the mapped-ID to the client device. The database server is further configured to, conditional on determining that the service information specifies that the request is associated with the second service determine whether the mapped-ID associated with the primary entity-ID is stored in the second cached copy, and conditional on determining that the mapped-ID is not stored in the second cached copy, determine whether the mapped-ID associated with the primary entity-ID is stored in the primary copy of the database. The database server is further configured to, conditional on determining that the mapped-ID is stored in one of the second cached copy and primary copy of the database, obtain the mapped-ID and transmitting the mapped-ID to the client device. The database server is further configured to, conditional on determining that the mapped-ID is not stored in the primary copy of the database, generate the mapped-ID associated with the primary entity-ID, transmit the mapped-ID to the client device, and store the primary entity-ID and the associated mapped-ID in a new row of the database.

Features of the database server may be as explained above in relation to the third aspect of the invention.

### BRIEF DESCRIPTION OF THE DRAWINGS

FIG. 1 is a flow diagram of an example process for generating a mapped-ID from a primary entity-ID;

FIG. 2 illustrates an example structure of the mapped-ID of FIG. 1;

FIG. 3 shows an example database generated according to process of FIG. 1;

FIG. 4 is a block diagram of an example computer network;

FIG. 5 is a diagram illustrating an example process of client-side caching;

FIG. 6 is a flow diagram illustrating a relative order of data guarantees provided by memories used in some embodiments to store the mappings;

FIG. 7 is a flow diagram of an example process for providing a client device with the mapped-ID;

FIG. 8 is a block diagram illustrating an example process for resolving conflicts between a plurality of databases;

FIG. 9 is a flow diagram of the process of FIG. 8;

FIG. 10 is a diagram illustrating an example process to preheat a database; and

FIG. 11 shows a computer system which can be used to perform the methods of FIG. 1, and 7 to 10.

### DETAILED DESCRIPTION

### Mapped-ID Generation

In general terms, a bidirectional mapping associates two elements with each other to form a one-to-one correspondence. For example, given a plurality of entities, each identified by a corresponding entity-ID, one may derive for each entity-ID an associated mapped-ID, such that each mapped-ID is unique to the associated entity-ID. In order to be able to perform a bi-directional lookup, i.e. to look up the associated mapped-ID for any particular entity-ID and vice versa, the mapping can be stored in a database. For example, the database may include a first column “entity-ID” and a second field “mapped-ID”, and each row is populated by an entity-ID and the associated mapped-ID. For a given entity-ID, an associated mapped-ID may be looked up in the database by finding the row that contains the entity-ID in the “entity-ID” column. Similarly, for a given mapped-ID, an associated entity-ID may be looked up in the database by finding the row that contains the mapped-ID in the “mapped-ID” column. However, this way of storing the mappings is not necessarily suitable for large databases. Databases can typically contain only up 100M records before read/write latencies become too high for many applications. However, some applications may require access to billions of mappings.

A known technique to improve the performance and scalability of large databases is partitioning (also referred to as sharding) the database in smaller partitions (or shards). This enables to distribute the database over several servers, computing systems, clusters and the like. One way of partitioning a database is referred to as horizontal sharding where the partitions have the same schema as the original database, and every row of the original database is allocated into a certain partitions based on a shard key. The shard key for each row may be derived from an element in a certain column of the row. However, horizontal sharding of the aforementioned example database would no longer allow efficient bidirectional lookup. For example, when the shard key is derived from the elements in the “entity-ID” column, an associated mapped-ID can still be efficiently looked up for a given entity-ID because the database partition in which the relevant row is stored can be derived from the entity-ID. The reverse look-up, however, is no longer efficient, because for a given mapped-ID, it is not possible to identify the database partition in which relevant row is stored.

To support bidirectional lookup, the aforementioned way of storing the mapping may be modified, such that each mapping may be stored in two rows in the database. In one row, the entity-ID is stored in first column and the mapped-ID in the second column. In another row, the mapped-ID is stored in first column and the entity-ID in the second column. The shard key may be derived from the elements in the first column, and the rows may be partitioned accordingly. Now efficient bidirectional look up is enabled because, for a given entity-ID, the partition in which the row containing the entity-ID in the first column and the mapped-ID in the second column can be identified. Similarly, for a given mapped-ID, the partition in which the row containing the mapped-ID in the first column and the entity-ID in the second column can be identified. While this modified storing scheme enables bidirectional lookup, because the entity-ID and mapped-ID are generally unrelated to each other, they will generate different shard key values, and will be stored in different partitions. Thus, writing such a mapping into the database may result in distributed transactions, i.e. accessing partitions on different servers, and may translate into additional latency.

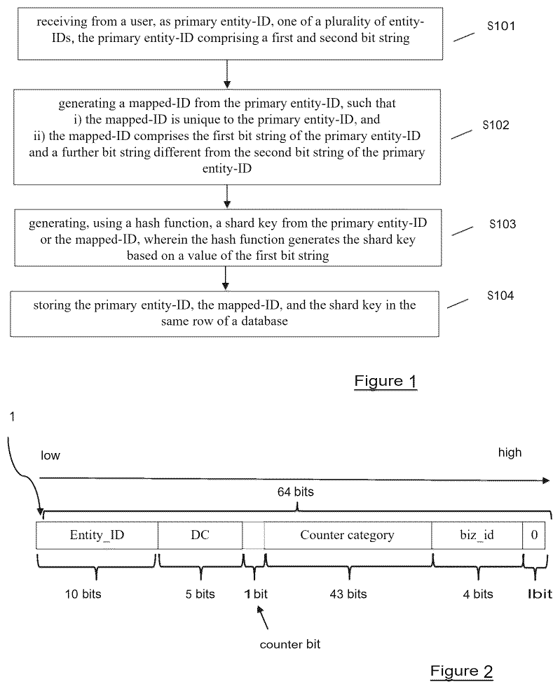

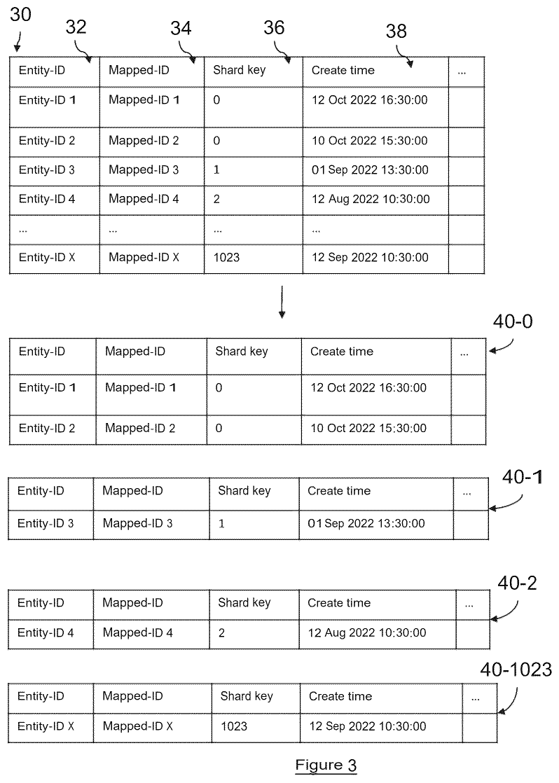

Referring to FIGS. 1 to 3, an example process is described that generates a mapped-ID from a given entity-ID for bidirectional lookup and overcomes drawbacks of the aforementioned methods. FIG. 1 shows the steps of the example process. FIG. 2 shows an example structure of a mapped-ID 1 illustrating S102 of the method of FIG. 1. FIG. 3 shows a database generated based on the process of FIG. 1.

Referring to FIG. 1, in step S101 a primary entity-ID is received from a user. The primary entity-ID is one of a plurality of entity-IDs and comprises a first and second bit string. In step S102 a mapped-ID is generated from the primary entity-ID. The mapped-ID is generated such that i) the mapped-ID is unique to the primary entity-ID, and ii) the mapped-ID comprises the first bit string of the primary entity-ID and a further bit string different from the second bit string of the primary entity-ID.

In an embodiment, the first bit string has a bit length of N and corresponds to the N least significant bits of both the primary entity-ID and the mapped-ID, where N is an integer number larger than zero. In an embodiment, the mapped-ID may be generated such that the values of the N least significant bits are identical to the values of the N least significant bits of the primary entity-ID.

In the embodiment shown in FIG. 2, the mapped-ID 1 has a bit length of 64 bits. In this embodiment, the first bit string of the primary entity-ID that is included in the mapped-ID 1 is 10 bits long. Further in the embodiment shown in FIG. 2, the further bit string may be 54 bits long.

In an embodiment, the mapped-ID is generated such that the mapped-ID is unique to the primary entity-ID by including a counter category value in the further bit string comprised in the mapped-ID. The counter category value may be provided by a counter module that stores and manages the counter category value. The counter module may be configured to change the counter category value every time a new mapped-ID is generated. The counter category value may be monotonically increased every time a new mapped-ID is generated. In an embodiment, the counter module is configured such that any counter category value is only provided once for the generation of a mapped-ID, i.e. the provided counter category value may be globally unique. Thus, a first mapped-ID comprising a counter category value that is lower than a counter category value of a second mapped-ID may indicate that the first mapped-ID was created at an earlier point in time. In the embodiment shown in FIG. 2, the counter category value is included in mapped-ID as a bit-string of length 43. This supports the generation of at least 243 unique mapped-IDs.

In an embodiment, the mapped-ID may be generated to further encode high level information such as business information in the further bit string of the mapped-ID. In the embodiment shown in FIG. 2, business information (biz_id) is encoded in a bit-string of length 4, and counter-source information are encoded into a single bit of the mapped-ID. The counter-source information may specify the counter module.

Referring back to FIG. 1, in step S103, using a hash function, a shard key is generated from the primary entity-ID or the mapped-ID, wherein the hash function generates the shard key based on a value of the first bit string. The hash function may be a computation method that receives an input and generates as output a value of a shard key, also referred to as simply shard key. The shard key may represent an integer number. In an embodiment where the first bit string has a bit length of N and corresponds to the N least significant bits of both the primary entity-ID and the mapped-ID, the hash function may be configured to generate the shard key based on the N least significant bits of the received input. In this embodiment, the hash function generates the same shard key value whether the primary entity-ID is received as input or the mapped-ID. Further in this embodiment, the shard key value represents a integer number from 0 to (2^{N}−1).

In step S104, the primary entity-ID, the mapped-ID, and the shard key are stored in the same row of a database. The database may be a relational database. The database may be stored on a database server. The database server may be a distributed computing system or a cluster of servers.

In an embodiment, the database may be configured as a partitioned database comprising a plurality of shards. Each shard may be associated with a different shard key value. In this case, the database server may be a cluster of servers, and each shard of the database may be stored on a different server. In this embodiment, in step S104 the primary entity-ID, the mapped-ID, and the shard key may be stored in the same row of a shard associated with the value of the shard key.

In an embodiment, steps S101 to S104 of FIG. 1 may be repeated for a large number of entity-IDs, such that the database comprises a plurality of rows, wherein each row comprises an entity-ID, an associated mapped-ID, and a shard key.

Advantages of the method described with reference to FIG. 1 are described by way of example with reference to FIG. 3. FIG. 3 shows a database 30 which may be generated by repeated performance of steps S101 to S104 of FIG. 1. The database 30 comprises a first field 32 “Entity-ID”, a second field “Mapped-ID”, and a third field “Sharding Key”. In an embodiment, the database 30 may also include further fields, for example a fourth field 38 “Create Time” which elements specify a time when the mapping stored in the corresponding row was created. In the embodiment the database 30 has X records, where X is a positive integer. Horizontal sharding may be applied to the database 30 to partition the database 30 in a plurality of partitions (commonly referred to as “shards”). FIG. 3 shows four of these partitions 40-0, 40-1, 40-2, and 40-1023. In the example shown in FIG. 3, the partition 40-0 is associated with the shard key value zero. Partition 40-0 comprises two rows corresponding to the two rows in the database 30 which have a shard key value equal to zero.

Further referring to FIG. 3, the partitioned database with its partitions 40-0 to 40-1023 enables efficient bidirectional lookup between entity-IDs and associated mapped-IDs, because the hash function may be used to identify the relevant partition of the database from an entity-ID or a mapped-ID. For example, for any given entity-ID, say “Entity-ID 3” in FIG. 3, the hash function may be used to identify the partition of the database which stores the relevant row, i.e. the row that includes the given entity-ID and the associated mapped-ID. In this example applying the hash function “Entity-ID 3” results in a shard key value equal to 1. The row containing “Entity-ID 3” and the associated mapped-ID “Mapped-ID 3” may be found in the corresponding partition 40-1. Similarly, if the reverse mapping is desired, the mapped-ID “Mapped-ID 3” may be provided to the hash function. Again the hash function may generate a shard key value equal to 1, because mapped-ID was created in S102 such that it comprises a first bit string of the associated entity-ID, and the hash function generates the shard key value based on value of the first bit string. Thus, the mapped-IDs generated in S102 deterministically generate the same shard key values as the associated entity-IDs. Further, because every mapping is stored in a single row, the required the storage size of the database is half compared to the two-row implementation mentioned above. Further, the write speed when storing a mapping is increase because only 1 row is stored, and local database transactions may be leveraged to ensure data atomicity instead of involving distributed transactions. Further, these mappings can be effectively stored in the same shard for SQL and NoSQL data stores.

### Caching Strategy

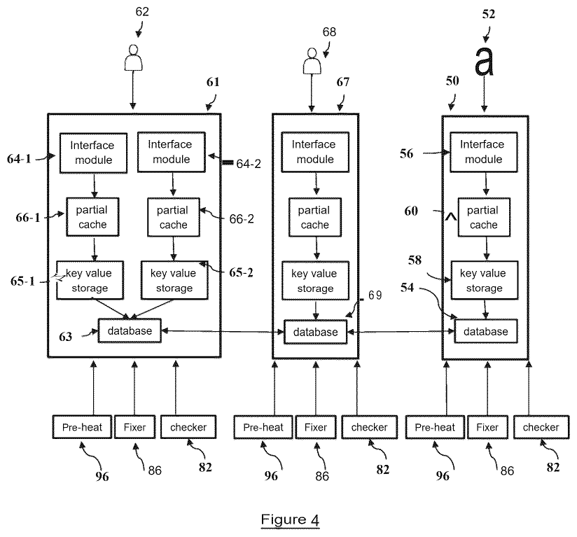

FIG. 4 shows a computer network comprising a first database server 50 connected via a network to client devices 52. The computer network enables the client devices 52 to transmit and receive data to and from the first database server 50. The database server may store a database 54 configured to store a plurality of rows, wherein each row comprises an entity-ID, an associated mapped-ID, and a shard key. The database 54 may be configured as a partitioned database comprising a plurality of shards. The first database server 50 may be configured to perform the method described with reference to FIG. 1. The computer network may further comprise second and third database servers 61, 67 which are below described in detail.

The first database server 50 may be further configured to provide a service to the client devices 52, which enable the client devices 52 to perform bidirectional lookup of entity-IDs and associated mapped-IDs stored in the database 54. The database server 50 may include an interface module 56 configured to receive from and send data to the client devices 52 via the network. In broad term, a client device may transmit to the interface module 56 of the first database server 50 a request, including an entity-ID, to receive from the first database server 50 the mapped-ID associated with the transmitted entity-ID. Similarly, a client device may transmit to the interface module 56 of the first database server 50 a request, including a mapped-ID, to receive from the first database server 50 the entity-ID associated with the transmitted mapped-ID.

The client devices 52 may be computer systems as described below with respect to FIG. 11. The first database server 50 may be implemented in a number of ways, for example on a single server, on a distributed computing system, on a cluster of servers or the like, a cloud-based system, etc. When the first database server 50 is implemented on a distributed computing system or on a cluster of servers, each shard of the partitioned database may be stored on a different server. The network may be the Internet or another network capable of linking together client devices 52 and the first database server 50.

A user having access to an entity-ID may run, on its client device, a local application. The local application may be configured to use a web application. The web application may receive as input a request which includes a mapped-ID, and may respond to a request with a response that includes the mapped-ID. To enable use of the web application, the local application may obtain the mapped-ID associated with the entity-ID by transmitting a corresponding request to the interface module 56 of first database server 50. In typical use cases, local application may transmit several lookup requests for the same entity-ID within in a short amount of time, which results in a high traffic load for the first database server 50.

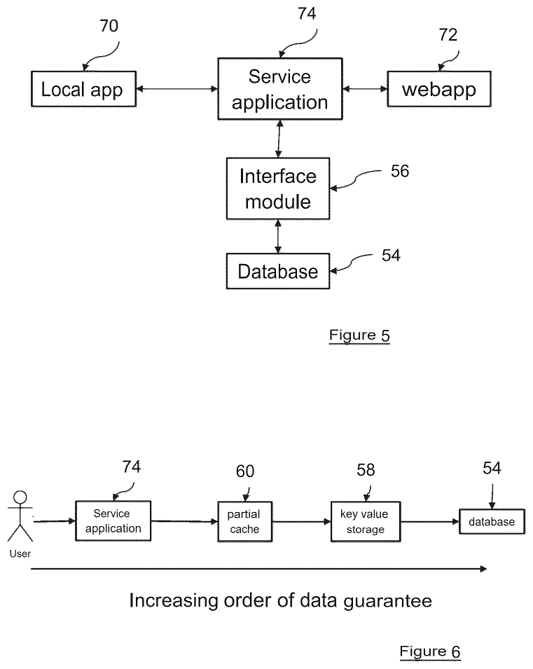

With reference to FIG. 5, a process is described in the following which enables a reduction in the number of redundant lookup requests sent to the interface module 56 by client-side caching of previously looked-up mappings. In this embodiment, the local application 70 may transmit the request for the web application 72 to a service application 74 which may run on a gateway server. The service application 74 may extract the entity-ID from the received request, and may transmit a request for providing the associated mapped-ID to the interface module 56 of the first database server 50. After receiving the mapped-ID, the service application 74 may replace the entity-ID included in the request received from the local application with the mapped-ID. The service application 74 may also store temporarily the entity-ID and mapped-ID as key/value pair in a local memory. When the local application 70 sends a subsequent request including the same entity-ID, the service application 74 may use the mapped-ID stored in the local memory instead of transmitting a request to the first database server 50. This reduces the traffic load of the database server. Similarly, the service application 74 may replace the mapped-ID in any response from the web application 72 with the associated entity-ID by either retrieving the entity-ID from the first database server 50 or, if available, by using the entity-ID stored in the local memory.

In an embodiment, the process described above with reference to FIG. 5 may also include automated cookie caching as described in the following to further reduce the traffic load caused by redundant lookup request and to provide fault tolerant setup for disaster recovery. In general terms, it is desirable to provide processes such that the bidirectional lookup service provided by database server 50 remains available even if its database is temporarily unavailable, e.g. because of downtime or extreme failure.

As described above, the service application 74 may extract the entity-ID from the request transmitted by local application 70, and may transmit a request for providing the associated mapped-ID to the interface module 56 of the first database server 50. After receiving the mapped-ID, the service application 74 may replace the entity-ID included in the request received from the local application with the mapped-ID. The service application 74 may also store temporarily the entity-ID and mapped-ID as key/value pair in a local memory. In this embodiment, the service application 74 may further encrypt the entity-ID and the mapped-ID using an encryption key stored on the user device. When the service application 74 receives a response from the web application 72, the service application 74 may replace the mapped-ID with the associated entity-ID by using the entity-ID stored in the key/value pair, and may transmit the response together with the encrypted entity-ID and mapped-ID to the local application 70. The service application 74 may further transmit expiration information specifying a lifetime of the encrypted entity-ID and the encrypted mapped-ID. The service application 74 may transmit the encrypted entity-ID and mapped-ID in form of a HTTP web cookie. The cookie may include, as expiration information, a time-to-live (TTL) value which describes a time period for which the cookie is valid. In response to receiving the cookie, local application 70 may store the cookie on the client device.

Any subsequent request transmitted by the local application 70 may include the encrypted cookie. In response to receiving the request, service application 74 may determine whether the cookie is valid by comparing the cookie's TTL value to the current time. If the cookie is determined to be invalid, the service application 74 may process the request, as described above, i.e. as if the request does not include the cookie. If the cookie is determined to be valid, then the service application 74 may decrypt the cookie using the encryption key to obtain the decrypted entity-ID and mapped-ID. Then service application 74 may use the decrypted entity-ID and mapped-ID to process the received request. Thus, this enables processing of lookup requests without transmitting lookup request to the database server. Thus, this further reduces the traffic load of the database server, and also enables continued availability of lookup service when the database server is temporarily not available.

Referring back to FIG. 4, the first database server 50 may further comprise a first memory 58 configured to cache the database 54. In an embodiment, the first memory 58 is a key-value storage. For example, the first memory 58 may cache the entire database 54. As described in further detail with respect to FIG. 5, in this case, lookup requests received by the interface module 56 may be directed to the first memory 58 instead of the database 54. This may reduce the latency of lookup request experienced by the client device 52 because the database cached in the first memory 58 can be searched faster than the database 54. The first database server 50 may further comprise a second memory 60 configured to partially cache the database 54. In this case the second memory 60 may store only a subset of the records stored in the first memory. Further, in this embodiment, lookup requests received by the interface module 56 may be directed to the second memory 60 instead of the first memory 58 or the database 54. This may further reduce the latency of lookup request experienced by the client device 52 because the partial database cached in the second memory 60 may be searched faster than the first memory 58 or the database 54.

In other words, the first database server 50 of FIG. 4 provides three access layers. A first layer comprises the second memory 60 may provide fast access. A storage size associated with the first layer may be smaller than the size of the entire database 54. A second layer comprises the first memory 60 may provide slower access than the first layer and faster access than a third layer. A storage size associated with the second layer may be larger than the storage size of the first layer. The third layer comprises the database 54 may provide slower access than any of the first and second layers. The third layer may store data permanently and/or durably.

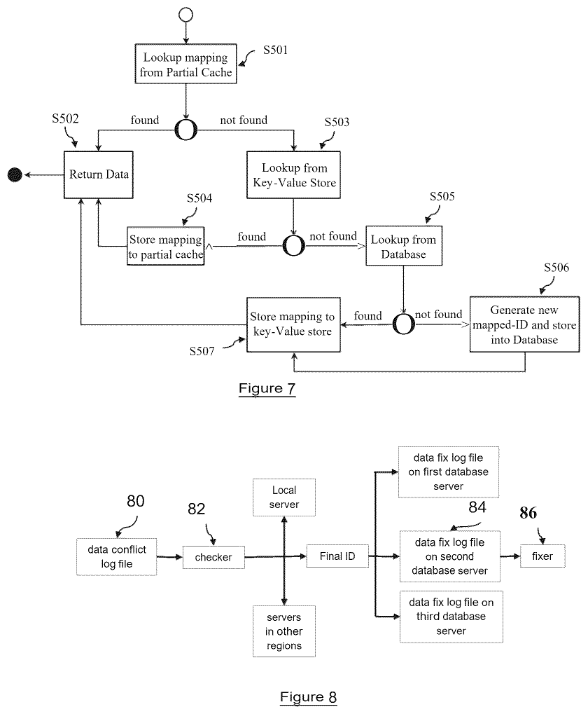

A bidirectional lookup service may reduce latencies and increase the number of user requests that it can process at any time by employing a caching strategy as described in the following with respect to FIGS. 6 and 7. FIG. 6 illustrates the relative order of data guarantees provided by the memories used in some embodiments to store the mappings. FIG. 7 shows a flow diagram of an example method of providing an application running on a client device with a mapped-ID associated with an entity-ID. In step S501, the client device may transmit a request including the mapped-ID. The request may be processed by the interface module 56 of the first database server 50. In step S502, the interface module 56 may determine whether the mapped-ID is stored in the second memory 60. If so, interface module 56 may retrieve the mapped-ID from the second memory 60 and may provide the mapped-ID to the application (S502). If the mapped-ID is not stored in the second memory 60, the interface module 56 may determine, in step S503, whether the mapped-ID is stored in the first memory 58. If so, interface module 56 may retrieve the mapped-ID from the first memory 58 and may provide the mapped-ID to the application (S502).

If the mapped-ID is not stored in the first or second memory 58, 60, the interface module 56 may determine whether the mapped-ID is stored in the database 54 (S505). If so, interface module 56 may retrieve the mapped-ID from the database 54. In step S507, the first and second memory 58, 60 may be updated so as to store the entity-ID and retrieved mapped-ID. The interface module 56 may provide the mapped-ID to the application (S502).

If the mapped-ID is not stored in the database 54, the database server may, in step S506, generate the mapped-ID from the transmitted entity-ID according to the method described with reference to FIG. 1, and store the entity-ID and generated mapped-ID in the database 54. The first and second memory 58, 60 may be updated so as to store the entity-ID and generated mapped-ID (S507). The interface module 56 may provide the mapped-ID to the application (S502).

In general terms, each of the users of the bidirectional mapping service may be associated with one of a plurality of services. Users associated with the same service may belong to the organisation, business unit or the like. The traffic load on the bidirectional mapping service caused by users associated with the same service may be similar, and may be different from the traffic load caused by users associated with another service. For example, users may be associated with a first or a second service. Users associated with the first service may cause a consistent traffic load, while user associated with the second service may cause a highly fluctuating traffic load. During periods of high traffic load caused by users of the second service, users of the first service may experience higher latencies.

Users of the first service may be protected from negative effects of such spiky traffic, as described in the following with reference to FIG. 4. The second database server 61, shown in FIG. 4, is a variation of the first database server 50. Similar to the first database server 50, the second database server 61 may transmit and receive data to and from client devices 62 over the network. Further, the database server may store a database 63 similar to database 54, i.e. configured to store a plurality of rows, wherein each row comprises an entity-ID, an associated mapped-ID, and a shard key. The database 63 may be configured as a partitioned database comprising a plurality of shards. The second database server 61 may be configured to perform the method described with reference to FIG. 1.

The second database server 61 may comprise two interface modules 64-1, 64-2, two first memories 65-1, 65-2, and two second memories 66-1, 66-2. The first memories 65-1, 65-2 may both be configured to independently cache the database 63. The first memory 65-1 may be configured to partially cache the second memory 66-1. The first memory 65-2 may be configured to partially cache the second memory 66-2.

A client device may transmit a request for a bidirectional lookup to the database server 63. The request may include an entity-ID and service information. The service information may specify to which service the user is associated. If the service information specifies that the user is associated with the first service, the interface module 64-1 may process the request. In this case, similar to steps S502-S507 of FIG. 7, the interface module 64-1 may determine whether the mapped-ID is stored in the second memory 66-1. If so, interface module 64-Imay retrieve the mapped-ID from the second memory 66-1 and may provide the mapped-ID to the user device. If the mapped-ID is not stored in the second memory 66-1, the interface module 64-1 may determine whether the mapped-ID is stored in the first memory 66-1. If so, interface module 64-1 may retrieve the mapped-ID from the first memory 66-1 and may provide the mapped-ID to the user device. If the mapped-ID is not stored in the first or second memory 65-1, 66-1, the interface module 64-1 may determine whether the mapped-ID is stored in the database 63. If so, interface module 64-1 may retrieve the mapped-ID from the database 63. The first and second memories 65-1, 65-2, 66-1, 66-2 may be updated so as to store the entity-ID and retrieved mapped-ID. The interface module 64-1 may provide the mapped-ID to the user device.

If the mapped-ID is not stored in the database 63, the database server may generate the mapped-ID from the transmitted entity-ID according to the method described with reference to FIG. 1, and store the entity-ID and generated mapped-ID in the database 63. The first and second memories 65-1, 65-2, 66-1, 66-2 may be updated so as to store the entity-ID and generated mapped-ID. The interface module 64-1 may provide the mapped-ID to the user device.

If the service information specifies that the user is associated with the second service, the interface module 64-2 may process the request. In this case, the interface module 64-2 may perform the aforementioned steps, i.e. interface module 64-2 may look up the mapped-ID in the second memory 66-2 and, if needed, in the first memory 65-2 and the database 63. Thus in this embodiment lookup requests from users associated with the first service may not be performed on the first and second memories 65-2, 66-2. Similarly, requests from users associated with the second service may not be performed on the first and second memories 65-1, 66-1. Because the first and second memories cache the database a large fraction of the lookup requests may be satisfied without accessing the database 63. Thus, in this embodiment heavy traffic caused by the users of the second service, does not affect the latency of requests by users from the first service, because most of these requests are already satisfied by accessing the first and second memories 65-1, 66-1 which do not receive any traffic from the users of the second service. Because all write operations are performed on the (common) database 63, data consistency is guaranteed, i.e. none of the first and second memories 65-1, 65-2, 66-1, 66-2 stores a mapping that is in conflict with any other mapping.

### Multi-Region Conflict Resolution

In broad terms, a user of the bidirectional mapping service who is located in a geographical location different from the location of the database server, may experience additional latency compared to users who are located closer to the database server. This additional latency may be in several tens or hundreds of milliseconds. It is desirable to reduce the latency of lookup requests by providing database servers in each geographical region where users are located, and directing mapping requests to the nearest database server. In this case, each of the database server may store a local replica of the database which contains the bidirectional mappings. As described above with reference to FIG. 5, a lookup request may result in the generation and storage of a new mapped-ID, for example when the requested mapping is not stored in the database. To keep also the latency of such write request low, a “master-master” implementation may be preferable. In such master-master implementation, each database server may be allowed to generate and store new mapping in its own replica of the database. After storing a new mapping, the other database replicas need to be updated. However, a data conflict may arise if two users from different geographical regions transmit simultaneously requests to two different database server from the same entity-ID. In this case the two database servers generate two different map-IDs from the same entity-ID. To avoid such problems of data consistency and data conflicts, it is therefore to provide a method that can identify and correct such conflicts.

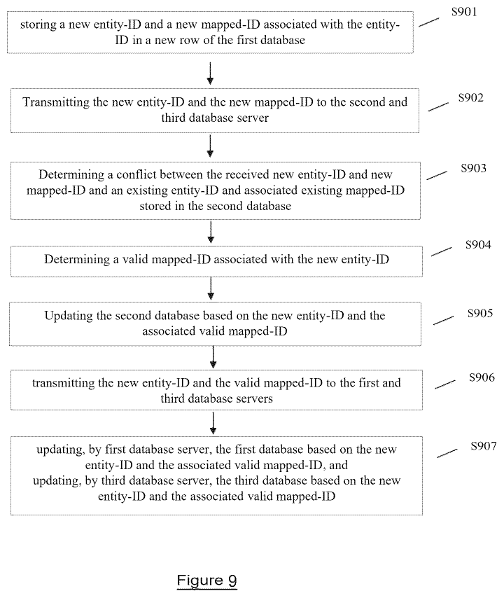

Referring to FIGS. 4, 8 and 9, a method of resolving data conflicts between different databases is described. FIG. 8 is a block diagram illustrating the architecture and data flow of the method. FIG. 9 is a flow diagram of the steps of the method.

In an embodiment, the computer network may comprise first, second and third database servers 50, 61, 67, as shown in FIG. 4 and described above. In this example, the third database server 67 is configured similar to the first database server 50, i.e. with one first and second memory, whereas the second database server is, as described above, configured to include two first and second memories. In some embodiments, any of the first, second and third database server may be configured either way, i.e. comprising one or two first and second memories.

In an embodiment, each of the first, second and third database servers may be located in a different geographical region, may be configured to host the bidirectional lookup service as described above, and may be configured to receive lookup requests from the respective client devices 52, 62, 68, as shown in FIG. 4. In this embodiment, the databases 54, 63, 69 may initially comprise the same data, i.e. the same mappings.

FIG. 9 is a flow diagram of an example method for resolving conflicts between the databases 54, 63, 69. In step S901, an entity-ID and a mapped-ID associated with the entity-ID is stored in a new row of the database 52 of the first database server 50. For example, the entity-ID and the mapped-ID may be generated and stored in response to a lookup request from a client device 52, as described above with reference to FIG. 7. This means that the entity-ID and mapped-ID may be stored in response to determining that the mapped-ID associated with the entity-ID is stored in database 52.

In step S902, the change of database 52, i.e. the new row including the entity-ID and the generated mapped-ID may be transmitted to the second and third database servers 61, 67. In step S903, in response to receiving the entity-ID and the mapped-ID, each of the second and third database servers 61, 67 may attempt updating their respective databases 63, 69. In other words, the second and third database servers 61, 67 may attempt adding the received entity-ID and mapped-ID to their respective databases 63, 69. The second database server 61 may a data conflict between the received entity-ID and mapped-ID and an another entity-ID and associated existing mapped-ID stored in the second database 63. For example, the second database server 61 may determine that the received entity-ID and the existing entity-ID are the same, and that the received mapped-ID and the existing mapped-ID are different. In this case, adding the received data in a new row of database 63 may result in a primary key/index guarantee failure.

In step S904, the second database server 61 determines which mapped-ID should be associated with the received entity-ID. In other words, the second database server 61 determines which a valid mapped-ID for the received entity-ID. The second database server 61 may write conflict data specifying the data conflict in a data conflict log file 80 stored in the second database server 61. The data conflict log file 80 may be implemented as a Kafka topic. In an embodiment, data conflict log file 80 may be mirrored to the first and third database servers 50, 67.

Checker module 82 is an application that runs on each of the first, second and third database server 50, 61, 67 and may be configured to read the data conflict log file 80. When the data conflict log file 80 is implemented as a Kafka topic, the checker module 82 may be implemented as a consumer subscribed to this topic. The checker module 82 running on the second database server 61 may determine the valid mapped-ID. To this end, the checker module 82 may transmit a lookup request to the third database server 67, the request including the entity-ID, and receive in response from the third database server 67, as a further mapped-ID, the mapped-ID associated with the transmitted entity-ID that is stored in database 69. The checker module 82 running on the second database server 61 may then select, as the valid mapped-ID, one of the mapped-ID initially received from the first database server, the existing mapped-ID stored in the second database 63, and the further mapped-ID received from the third database server 67.

In an embodiment, the checker module 82 may select the valid mapped-ID by determining a counter value for each of the mapped-ID initially received from the first database server, the existing mapped-ID stored in the second database 63, and the further mapped-ID received from the third database server 67, and selecting, as the valid mapped-ID, the mapped-ID with the lowest counter value. Alternatively, when, as described above with reference to FIGS. 2 and 3, the first, second and third databases 52, 63, 69 further store in each row a creation timestamp specifying the time when the mapped entity-ID stored in said row was created, the first database server 50 may also transmit in step S902 the corresponding creation timestamp to the second database server 61 when transmitting the entity-ID and the mapped-ID. Further in this embodiment, the third database server 67 may also transmit the corresponding creation timestamp to the second database server 61 when transmitting the further mapped-ID. In this case, the checker module 82 may select the valid mapped-ID from the mapped-ID initially received from the first database server 50, the existing mapped-ID stored in the second database 63, and the further mapped-ID received from the third database server 67, the one with the earliest timestamp.

In step S905, the second database server 61 may write the valid mapped-ID in a data fix log file 84 stored in the second database server 61. The data fix log file 84 may be implemented as a Kafka topic.

Fixer module 86 is an application that runs on each of the first, second and third database server 50, 61, 67 and may be configured to read the data fix log file 84. When the data fix log file 84 is implemented as a Kafka topic, the fixer module 86 may be implemented as a consumer subscribed to this topic. In the case when checker module 82 determined in step S904 that the valid mapped-ID is not the one stored in database 63, the fixer module 86 running on the second database server 61 may, in response to reading the data fix log 84, update database 63 such that the entity-ID is stored together with valid mapped-ID and the corresponding previously stored mapped-ID is removed.

In step S906, the entity-ID and the valid mapped-ID may be transmitted to the first and third database servers 50, 61. To this end, the data fix log file 84 may be mirrored to the first and third database servers 50, 67. In step S907, the first and third database server 50, 67, may update the respective first and third databases 52, 63, 69 based on the entity-ID and the associated valid mapped-ID. Depending on whether the first and third databases 52, 69 store the valid mapped-ID, the respective fixer modules 86 running on the first and third database server 50, 67 may, in response to reading the mirrored data fix log, update databases 52, 69 such that the entity-ID is stored together with valid mapped-ID and, if applicable, the corresponding previously stored mapped-ID is removed. This enables to resolve any data conflict that may be caused by multiple (near) simultaneous lookup requests sent to database servers located in different geographical regions.

### Pre-Heating Architecture

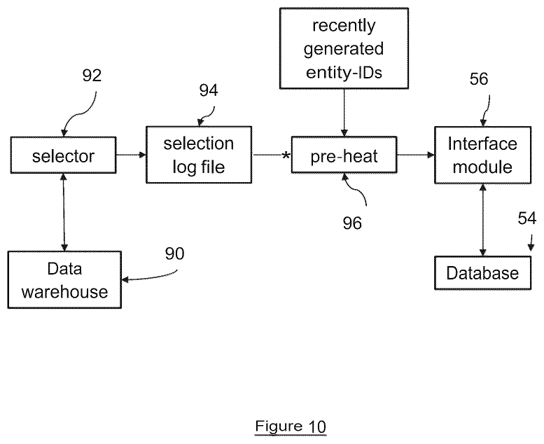

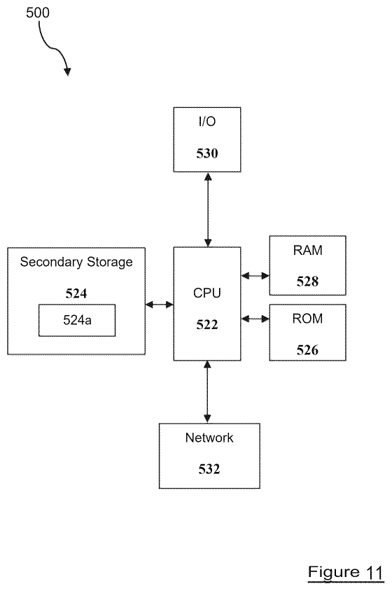

In general terms, the bidirectional lookup service described above may be used for a large number of entity-IDs, for example several billions. Although each mapped-ID may be generated only when the first corresponding user request is sent to the database server, it is often desirable to pre-populate (commonly referred to as pre-heating) the database. This is because write speeds are typically lower than read speeds, and users may experience large latencies if the database server receives large amounts of write request during for example peak periods. It therefore desirable to provide a process of continuously pre-populating the database with the most relevant mappings. Such a process is described in the following with reference to FIG. 10.

In an embodiment, a large number of entity-IDs may be stored in a data warehouse 90. The data warehouse 90 may be stored on a cluster or server connected to the network. In an embodiment, the data warehouse may be stored in the database server 50. In another embodiment, the data warehouse 90 is stored on a separate cluster or server. The number of stored entity-ID may be greater than 1 billion. In the data warehouse 90, each of the stored entity-IDs may be associated with a timestamp indicating the last time when this entity-ID has been used, for example in a web application.

A selector module 92 running on the cluster of the data warehouse 90 may be configured to query from the data warehouse the entity-IDs which timestamp is within a selection period. The selection period may be the past 3 months. The selector module 92 may write the received entity-IDs into a selection log file 94. The selection log file 94 may be implemented as a Kafka topic. In an embodiment, selection log file 94 may be mirrored to the database server 50.

Pre-heat module 96 is an application that runs on the database server 50 and may be configured to read the selection log file 94. When the data conflict log file 80 is implemented as a Kafka topic, the pre-heat module 96 may be implemented as a consumer subscribed to this topic. In response to reading the selection log file 94, pre-heat module 96 may transmit lookup requests for each of the entity-IDs in the selection log file 94 to the interface module 56 of database server 50, so as to prompt the database server 50 to generate and store associated mapped-IDs in database 54, as described above with reference to FIGS. 1 and 7. In an embodiment, the pre-heat module 96 may be further configured to receive entity-IDs that have been recently generated, for example on the previous day, for example by the web application. In response to receiving the recently generated entity-IDs, pre-heat module 96 may transmit lookup requests for each of these entity-IDs to the interface module 56 of database server 50, so as to prompt the database server 50 to generate and store associated mapped-IDs in database 54. This enables to increase the stability of the bidirectional lookup service, and to reduce latency caused by large amounts of write requests, because the database is pre-populated with the entity-IDs that have recently been used or generated and which are therefore most likely to be requested by users in the near future. While this process is described with reference to database 50, those skilled in the art will appreciate that various modifications, for example applying this process to all database servers in the network, may be made to the above described embodiment without departing from the scope of the present invention.

FIG. 11 is a block diagram showing the technical architecture 500 of a server which can perform some or all of a method according to FIGS. 1, 2, 5, 6, 9 or FIG. 10. The technical architecture includes a processor 522 (which may be referred to as a central processor unit or CPU) that is in communication with memory devices including secondary storage 524 (such as disk drives), read only memory (ROM) 526, random access memory (RAM) 528. The processor 522 may be implemented as one or more CPU chips. The technical architecture may further comprise input/output (I/O) devices 530 and network connectivity devices 532.

The secondary storage 524 typically comprises of one or more disk drives or tape drives and is used for non-volatile storage of data and as an over-flow data storage device if the RAM 528 is not large enough to hold all working data. The secondary storage 524 may be used to store programs which are loaded into the RAM 528 when such programs are selected for execution.

In this embodiment, the secondary storage 524 has an order processing component 524a comprising non-transitory instructions operative by the processor 522 to perform various operations of the method of the present disclosure. The ROM 526 is used to store instructions and perhaps data which are read during program execution. The secondary storage 524, the RAM 528, and/or the ROM 526 may be referred to in some contexts as computer readable storage media and/or non-transitory computer readable media.

I/O devices 530 may include printers, video monitors, liquid crystal displays (LCDs), plasma displays, touch screen displays, keyboards, keypads, switches, dials, mice, track balls, voice recognizers, card readers, paper tape readers, or other well-known input devices.

The processor 522 executes instructions, codes, computer programs, scripts which it accesses from hard disk, floppy disk, optical disk (these various disk based systems may all be considered secondary storage 524), flash drive, ROM 526, RAM 528, or the network connectivity devices 532. While only one processor 522 is shown, multiple processors may be present. Thus, while instructions may be discussed as executed by a processor, the instructions may be executed simultaneously, serially, or otherwise executed by one or multiple processors.

Although the technical architecture is described with reference to a computer, it should be appreciated that the technical architecture may be formed by two or more computers in communication with each other that collaborate to perform a task. For example, but not by way of limitation, an application may be partitioned in such a way as to permit concurrent and/or parallel processing of the instructions of the application. Alternatively, the data processed by the application may be partitioned in such a way as to permit concurrent and/or parallel processing of different portions of a data set by the two or more computers. In an embodiment, virtualization software may be employed by the technical architecture 500 to provide the functionality of a number of servers that is not directly bound to the number of computers in the technical architecture 500. In an embodiment, the functionality disclosed above may be provided by executing the application and/or applications in a cloud computing environment. Cloud computing may comprise providing computing services via a network connection using dynamically scalable computing resources. A cloud computing environment may be established by an enterprise and/or may be hired on an as-needed basis from a third party provider.

By programming and/or loading executable instructions onto the technical architecture, at least one of the CPU 522, the RAM 528, and the ROM 526 are changed, transforming the technical architecture in part into a specific purpose machine or apparatus having the novel functionality taught by the present disclosure. It is fundamental to the electrical engineering and software engineering arts that functionality that can be implemented by loading executable software into a computer can be converted to a hardware implementation by well-known design rules.

Whilst the foregoing description has described exemplary embodiments, it will be understood by those skilled in the art that many variations of the embodiment can be made within the scope and spirit of the present invention.

1. A computer-implemented method comprising:
a) receiving from users, respective primary entity-IDs, each primary entity-ID comprising a first and second bit string; and
b) generating respective mapped-IDs from each of the primary entity-IDs, such that
i) each of the mapped-IDs is unique, and
ii) the mapped-IDs each comprise the first bit string of the associated primary entity-ID and a third bit string different from the second bit string of the associated primary entity-ID.

2. The method according to claim 1, wherein the first bit strings have a bit length N, and the primary entity-IDs and the mapped-IDs comprise the first bit strings as the N least significant bits.

3. The method according to claim 1, wherein the bit length N of each first bit string is 10, and each mapped-ID has a bit length of 64.

4. The method according to claim 1, further comprising maintaining a counter, wherein the third bit strings of the mapped-IDs comprise counter information obtained from the counter.

5. The method according to claim 1, further comprising, for each primary entity-ID, a step of generating, using a hash function, a shard key from the primary entity-ID or the associated mapped-ID, wherein the hash function generates the shard key based on a value of the first bit string.

6. The method according to claim 5 further comprising, for each primary entity-ID, a step of storing the primary entity-ID, the associated mapped-ID, and the shard key in the same row of a database.

7. The method according to claim 6, wherein the database is configured as a partitioned database comprising a plurality of shards, each shard being associated with a different shard key value, and wherein storing the primary entity-ID, the mapped-ID, and the shard key in the same row of a database comprises storing the primary entity-ID, the mapped-ID, and the shard key in the same row of a shard associated with the value of the shard key.

8. A computer-implemented method of resolving conflicts between a first and a second database, the first and second databases having respective pluralities of rows, each row storing an entity-ID and a mapped-ID associated with the entity-ID, the method comprising:
(a) storing a new entity-ID and a new mapped-ID associated with the entity-ID in a new row of the first database;
(b) determining a conflict between the new entity-ID and new mapped-ID and an existing entity-ID and associated existing mapped-ID stored in the second database;
(c) determining a valid mapped-ID associated with the new entity-ID, and
(d) conditional on determining that the valid mapped-ID and the existing mapped-ID stored in the second database are different, updating the second database based on the new entity-ID and the associated valid mapped-ID.

9. The method according to claim 8, wherein step (b) comprises determining that the new entity-ID and the existing entity-ID are the same, and that the new mapped-ID and the existing mapped-ID are different.

10. The method according to claim 8, wherein a third database has a further plurality of rows, each row storing an entity-ID and a mapped-ID associated with the entity-ID, and step (d) comprises:
retrieving, from the third database, a further mapped-ID associated with the new mapped-ID, and
selecting as the valid mapped-ID associated with the new entity-ID, one of the new mapped-ID, the existing mapped-ID stored in the second database and the further mapped-ID retrieved from the third database.

11. The method according to claim 10, wherein the step of selecting the valid mapped-ID comprises:
determining a counter value for each of the new mapped-ID, the existing mapped-ID stored in the second database and the further mapped-ID retrieved from the third database, and selecting, as the valid mapped-ID, the mapped-ID with the lowest counter value.

12. The method according to claim 10, wherein the first, second and third databases further store in each row a creation timestamp specifying a time when the mapped entity-ID stored in said row was created, and the step of selecting the valid mapped-ID comprises:
selecting from the new mapped-ID, the existing mapped-ID stored in the second database and the further mapped-ID retrieved from the third database the one with the earliest timestamp.

13. The method according to claim 8, further comprising:
(e) conditional on determining that the valid mapped-ID and the new mapped-ID are different, updating the first database based on the new entity-ID and the associated valid mapped-ID; and
(f) conditional on determining that the valid mapped-ID and the further mapped-ID retrieved from the third database are different, updating the third database based on the new entity-ID and the associated valid mapped-ID.

14. The method according to claim 8, further comprising an initial step of generating the new mapped-ID from the new entity-ID according to a method comprising:
a) receiving from users, respective primary entity-IDs, each primary entity-ID comprising a first and second bit string; and
b) generating respective mapped-IDs from each of the primary entity-IDs, such that
i) each of the mapped-IDs is unique, and
ii) the mapped-IDs each comprise the first bit string of the associated primary entity-ID and a third bit string different from the second bit string of the associated primary entity-ID.

15. A computer-implemented method of processing, by a database server, a request from a client device for providing a mapped-ID associated with a primary entity-ID, the database server storing a primary copy of a database having a plurality of rows, each row comprising one of a plurality of entity-IDs and a mapped-ID associated with the entity-ID, and the database server further storing first and second cached copies of the database, the method comprising:
(a) receiving the request from the client device, the request comprising the primary entity-ID and service information specifying whether the request is associated with a first or second service;
(b) conditional on determining that the service information specifies that the request is associated with the first service:
(b1) determining whether the mapped-ID associated with the primary entity-ID is stored in the first cached copy;
(b2) conditional on determining that the mapped-ID is not stored in the first cached copy, determining whether the mapped-ID associated with the primary entity-ID is stored in the primary copy of the database;
(b3) conditional on determining that the mapped-ID is stored in one of the first cached copy and the primary copy of the database, obtaining the mapped-ID and providing the mapped-ID to the client device;
(c) conditional on determining that the service information specifies that the request is associated with the second service:
(c1) determining whether the mapped-ID associated with the primary entity-ID is stored in the second cached copy;
(c2) conditional on determining that the mapped-ID is not stored in the second cached copy, determining whether the mapped-ID associated with the primary entity-ID is stored in the primary copy of the database;
(c3) conditional on determining that the mapped-ID is stored in one of the second cached copy and primary copy of the database, obtaining the mapped-ID and transmitting the mapped-ID to the client device; and
(d) conditional on determining that the mapped-ID is not stored in the primary copy of the database:
(d1) generating the mapped-ID associated with the primary entity-ID;
(d2) transmitting the mapped-ID to the client device, and
(d3) storing the primary entity-ID and the associated mapped-ID in a new row of the database.

16. The method according to claim 15, wherein the first and second cached copies fully cache the database, and the database server further stores a first partially cached copy of the first cached copy and a second partially cached copy of the second cached copy;
wherein step (b1) of the method comprises:
determining whether the mapped-ID associated with the primary entity-ID is stored in the first partially cached copy;
conditional on determining that the mapped-ID is not stored in the first partially cached copy, determining whether the mapped-ID associated with the primary entity-ID is stored in the first cached copy; and
wherein the step (c1) of the method comprises:
determining whether the mapped-ID associated with the primary entity-ID is stored in the second partially cached copy, and
conditional on determining that the mapped-ID is not stored in the second partially cached copy, determining whether the mapped-ID associated with the primary entity-ID is stored in the second cached copy.

17-29. (canceled)

30. The method according to claim 14, wherein the first bit strings have a bit length N, and the primary entity-IDs and the mapped-IDs comprise the first bit strings as the N least significant bits.

31. The method according to claim 14, wherein the bit length N of each first bit string is 10, and each mapped-ID has a bit length of 64.

32. The method according to claim 14, wherein the third bit strings of the mapped-IDs comprise counter information obtained from the counter.

33. The method according to claim 14, further comprising, for each primary entity-ID, a step of generating, using a hash function, a shard key from the primary entity-ID or the associated mapped-ID, wherein the hash function generates the shard key based on a value of the first bit string.
